(19) United States
(12) Patent Application Publication
(10) Pub. No.: US 2008/0064826 A1
(43) Pub. Date: Mar. 13, 2008

(54) Polyamide resin composition

(76) Inventor: Kenichi Shinohara, Tochigi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/518,056

(22) Filed: Sep. 8, 2006

(51) Int. Cl. C08G 69/48

(52) U.S. Cl. 525/420

(57) ABSTRACT

A polyamide composition having good impact resistance and stiffness comprising polycarbodiimide, glass fibers, and, optionally, impact modifiers. Articles formed therefrom are also disclosed.

### FIELD OF THE INVENTION

The present invention relates to polyamide resin compositions. More particularly, the present invention relates to a polyamide resin compositions comprising polycarbodiimide, glass fibers, and, optionally, impact modifiers. The polyamide compositions have good impact resistance as well as good stiffness.

### BACKGROUND OF THE INVENTION

Polyamide compositions are used in a wide variety of applications because of their excellent physical properties, chemical resistance, and the ease of processing said compositions (that is, “processability”). Common applications include automotive parts and electrical and electronic parts.

Though polyamides have good inherent toughness or impact resistance, low-elasticity rubber impact modifiers are often used to increase the toughness of polyamide compositions. However, the addition of these impact modifiers can reduce the stiffness or rigidity of the resulting polyamide resin.

Stiffness in polyamide compositions can be improved by the addition of reinforcing agents and fillers, particularly inorganic reinforcing agents (for example, glass fibers) and mineral fillers, but this measure can reduce the toughness of the resulting resin.

In summary, the simple addition of a rubber impact modifier and/or an inorganic reinforcing agent is typically not desirable to improve both stiffness and toughness in polyamide compositions.

It is known that impact strength can be markedly improved by adding an elastomeric material modified with reactive functional groups to polyamide resins. For example, a toughened polyamide blend is disclosed in U.S. Pat. No. 4,346,194, which contains: a) 60 to 97 weight percent polyamide (a mixture of 66 nylon and 6 nylon); and, b) 3 to 40 weight percent of a polymeric toughening agent selected from (i) an elastomeric olefin copolymer with carboxyl or carboxylate functionality or (ii) an ionic copolymer of at least one a-olefin and at least one α,β-unsaturated carboxylic acid, which can contain a ternary copolymerizable monomer, and which is at least partially ionized by neutralizing its acidic ingredients with a metallic basic salt.

Polyamide compositions have been disclosed in which melt viscosity and resistance to hydrolysis have been improved by the addition of polycarbodiimides. For example, a polycarbodiimide modified tractable polyamide product is disclosed in U.S. Pat. No. 4,128,599 with unique rheological properties and improved shear properties. It is disclosed that the polycarbodiimide functions as a bridging agent in which the carbodiimide group bridges the terminal COOH and the NH₂ group in the polyamide.

U.S. Pat. No. 5,360,888 discloses a polyamide resin composition containing 0.1 to 5 weight aromatic polycarbodiimide that is stabilized to hydrolysis at high temperatures.

U.S. patent application publication 2004/0010094 discloses a polyamide resin composition comprising aromatic or aliphatic polycarbodiimides in a ratio of 0.10 to 3.5 molar equivalents of carbodiimide groups to acid end groups in the polyamide.

An object of the invention is to provide a composition showing both good stiffness and good toughness and to provide an article molded from the composition.

### SUMMARY OF THE INVENTION

In one aspect, the present invention is a polyamide composition comprising (a) at least one polyamide component; (b) glass fibers; and (c) at least one polycarbodiimide component. The polyamide composition of the present invention can further include (d) at least one impact modifier. Furthermore, an article molded from the above composition is provided. The molded article of the present invention shows a significant toughness and a significant stiffness.

### BRIEF DESCRIPTION OF THE DRAWING

FIG. 1 is a graph illustrating the effect of the present invention. X-axis means Flexural Modulus meaning rigidity or stiffness. Y-axis means Charpy Izod Impact meaning toughness.

### DETAILED DESCRIPTION OF THE INVENTION

The compositions of the present invention comprise polyamide, polycarbodiimide, glass fibers, and, optionally, impact modifiers. As aforementioned, a polyamide resin formed by the addition of either rubber impact modifiers or inorganic reinforcing agents or both to polyamides alone doesn't provide both properties of desirable stiffness and desirable toughness. However, surprisingly, a polyamide composition containing a polyamide, a glass fiber and a polycarbodiimide show both good stiffness and good toughness. Further, those properties can be improved by the addition of impact modifier.

### Polyamide

The polyamide of the composition of the present invention comprises at least one thermoplastic polyamide. The polyamide may be homopolymer, copolymer, terpolymer or higher order polymer. Blends of two or more polyamides may be used. Suitable polyamides can be condensation products of dicarboxylic acids or their derivatives and diamines, and/or aminocarboxylic acids, and/or ring-opening polymerization products of lactams. Suitable dicarboxylic acids include, adipic acid, azelaic acid, sebacic acid, dodecanedioic acid, isophthalic acid and terephthalic acid. Suitable diamines include tetramethylenediamine, hexamethylenediamine, octamethylenediamine, nonamethylenediamine, dodecamethylenediamine, 2-methylpentamethylenediamine, 2-methyloctamethylenediamine, trimethylhexamethylenediamine, bis(p-aminocyclohexyl)methane, m-xylylenediamine, and p-xylylenediamine. A suitable aminocarboxylic acid is 11-aminododecanoic acid. Suitable lactams include caprolactam and laurolactam.

Preferred aliphatic polyamides include polyamide 6; polyamide 66; polyamide 46; polyamide 69; polyamide 610; polyamide 612; polyamide 1010; polyamide 11; polyamide 12; semi-aromatic polyamides such as poly(m-xylylene adipamide) (polyamide MXD6), poly(dodecamethylene terephthalamide) (polyamide 12T), poly(decamethylene terephthalamide) (polyamide 10T), poly(nonamethylene terephthalamide) (polyamide 9T), the polyamide of hexamethylene terephthalamide and hexamethylene adipamide (polyamide 6T/66); the polyamide of hexamethyleneterephthalamide and 2-methylpentamethyleneterephthalamide (polyamide 6T/DT); the polyamide of hexamethylene isophthalamide and hexamethylene adipamide (polyamide 6I/66); the polyamide of hexamethylene terephthalamide, hexamethylene isophthalamide, and hexamethylene adipamide (polyamide 6T/6I/66) and copolymers and mixtures of these polymers.

Examples of suitable aliphatic polyamides include polyamide 66/6 copolymer; polyamide 66/68 copolymer; polyamide 66/610 copolymer; polyamide 66/612 copolymer; polyamide 66/10 copolymer; polyamide 66/12 copolymer; polyamide 6/68 copolymer; polyamide 6/610 copolymer; polyamide 6/612 copolymer; polyamide 6/10 copolymer; polyamide 6/12 copolymer; polyamide 6/66/610 terpolymer; polyamide 6/66/69 terpolymer; polyamide 6/66/11 terpolymer; polyamide 6/66/12 terpolymer; polyamide 6/610/11 terpolymer; polyamide 6/610/12 terpolymer; and polyamide 6/66/PACM (bis-p-{aminocyclohexyl}methane)terpolymer.

A preferred polyamide is polyamide 66 in terms of maximizing effect of the addition of polycarbodiimide. Blends of polyamides with other thermoplastic polymers may be used. The polyamide is preferably present in about 65 to about 84.7 weight percent, or more preferably about 70 to about 80 weight percent, based on the total weight of the composition.

### Glass Fibers

Any glass fibers available for the reinforcement of plastic materials can be suitable for use. Glass fibers includes, but are not limited to, chopped strand E-glass fibers.

In the case that an impact modifier is not included in the composition, the glass fibers are preferably present in the composition in an amount of from about 15 to about 39.7 weight percent, or more preferably from about 20 to about 35 weight percent, based on the total weight of the composition. In the case that the impact modifier is included in the composition, the glass fibers are preferably present in the composition in an amount of from about 3 to about 20 weight percent, more preferably from about 5 to about 15 weight percent, or still more preferably from about 8 to about 12 weight percent, based on the total weight of the composition. When combined within the above range in a polyamide composition as taught and claimed herein a resin article with desirable stiffness and toughness can be obtained.

### Polycarbodiimide

The polycarbodiimide can be an aliphatic, alicyclic, or aromatic polycarbodiimide, and may be represented by the following chemical formula:

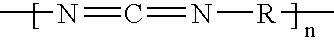

where the R group represents an aliphatic, alicyclic, or aromatic group.

Examples of suitable R groups include, but are not limited to, divalent radicals derived from 2,6-diisopropylbenzene, naphthalene, 3,5-diethyltoluene, 4,4′-methylene-bis(2,6-diethylenephenyl), 4,4′-methylene-bis(2-ethyle-6-methylphehyl), 4,4′-methylene-bis(2,6-diisopropylephenyl), 4,4′-methylene-bis(2-ethyl-5-methylcyclohexyl), 2,4,6-triisopropylephenyl, n-hexane, cyclohexane, dicyclohexylmethane, and methylcyclohexane, and the like.

Polycarbodiimides can be manufactured by a variety of methods known to those skilled in the art. Conventional manufacturing methods are described in U.S. Pat. No. 2,941,956 or Japan Kokoku patent application S47-33279, J. Org. Chem., 28, 2069-2075 (1963), Chemical Reviews, 81, 619-621 (1981). Typically, they are manufactured by the condensation reaction accompanying the decarboxylation of organic diisocyanate. This method yields an isocyanate-terminated polycarbodiimide.

Aromatic diisocyanates, aliphatic diisocyanates, and alicyclic diisocyanates, or mixtures thereof, for example, can be used to prepare polycarbodiimides. Suitable examples include 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-trilene diisocyanate, 2,6-trilene diisocyanate, mixtures of 2,4-trilene diisocyanate and 2,6-trilene diisocyanate, hexamethylene diisocyanate, cyclohexane-1,4-diisocyanate, xylylene diisocyanate, isophoron diisocyanate, dicyclohexylmethane-4,4′-diisocyanate, methylcyclohexane diisocyanate, tetramethylxylylene diisocyanate, 2,6-diisopropylephenyl isocyanate, and 1,3,5-triisopropyl benzene-2,4-diisocyanate, and the like.

Chain termination agents can be used to control the polymerization and yield polycarbodiimides having end groups other than isocyanates. Examples suitable chain termination agents include monoisocyanates. Suitable monoisocyanates include phenyl isocyanate, tolyl isocyanate, dimethylphenyl isocyanate, cyclohexyl isocyanate, butyl isocyanate, and naphthyl isocyanate, etc.

Other suitable chain termination agents include alcohols, amines, imines, carboxylic acids, thiols, ethers, and epoxides. Examples include methanol, ethanol, phenols, cyclohexanol, N-methylethanolamine, poly(ethylene glycol)monomethylethers, poly(propylene glycol)monomethylethers, diethylamine, dicyclohexylamine, butylamine, cyclohexylamine, citric acid, benzoic acid, cyclohexanoic acid, ethylene mercaptan, arylmercaptan, and thiophenol.

The reaction of organic diisocyanates to form polycarbodiimides is performed in the presence of a carbodiimidation catalyst such as 1-phenyl-2-phospholene-1-oxide, 3-methyl-1-phenyl-2-phospholene-1-oxide, 1-ethyl-2-phospholene-1-oxide, 3-methyl-e-phospholene-1-oxide, and 3-phospholene isomers of the foregoing. Of these, 3-methyl-1-phenyl-2-phospholene-1-oxide is particularly reactive.

The polycarbodiimide is preferably present in the composition in an amount of from about 0.3 to about 5 weight percent, or more preferably greater than from about 0.5 to about 2.0 weight percent, based on the total weight of the composition. Within the above range, the resin article with excellent stiffness and toughness can be obtained.

### Impact Modifier

The optional impact modifier is any impact modifier that is known or is found to be suitable for toughening polyamide resins. Examples of suitable impact modifiers are given in U.S. Pat. No. 4,174,358, which is hereby incorporated by reference herein. Preferred impact modifiers are carboxyl-substituted polyolefins, which are polyolefins that have carboxylic moieties attached thereto, either on the polyolefin backbone itself or on side chains. By “carboxylic moiety” is meant carboxylic groups such as one or more of dicarboxylic acids, diesters, dicarboxylic monoesters, acid anhydrides, monocarboxylic acids and esters, and salts. Carboxylic salts are neutralized carboxylic acids. Useful impact modifiers are dicarboxyl-substituted polyolefins, which are polyolefins that have dicarboxylic moieties attached thereto, either on the polyolefin backbone itself or on side chains. By “dicarboxylic moiety” is meant dicarboxylic groups such as one or more of dicarboxylic acids, diesters, dicarboxylic monoesters, and acid anhydrides. Preferred polyolefins are copolymers of ethylene and one or more additional olefins, wherein the additional olefins are hydrocarbons.

The impact modifiers will preferably be based an olefin copolymer, such as an ethylene/a-olefin polyolefin. Examples of olefins suitable for preparing the olefin copolymer include alkenes having 2 to 8 carbon atoms, such as ethylene, propylene, 1-butene, 1-heptene, or 1-hexene. Diene monomers such as 1,4-hexadiene, 2,5-norbornadiene, 1,7-octadiene, and/or dicyclopentadiene may optionally be used in the preparation of the polyolefin. Preferred olefin copolymers are polymers derived from ethylene, at least one α-olefin having 3 to 6 carbon atoms, and at least one unconjugated diene. Particularly preferred polyolefins are ethylene-propylene-diene (EPDM) polymers made from 1,4-hexadiene and/or dicyclopentadiene, and ethylene/propylene copolymers.

The carboxyl moiety may be introduced to the olefin copolymer to form the impact modifier during the preparation of the polyolefin by copolymerizing with an unsaturated carboxyl-containing monomer. The carboxyl moiety may also be introduced by grafting the polyolefin with an unsaturated grafting agent containing a carboxyl moiety, such as an acid, ester, diacid, diester, acid ester, or anhydride.

Examples of suitable unsaturated carboxylic-containing comonomers or grafting agents include maleic acid, maleic anhydride, monoester maleate, metal salts of monoethylester maleate, fumaric acid, monoethylester fumarate, itaconic acid, vinylbenzoic acid, vinylphthalic acid, metal salts of monoethylester fumarate, and methyl, propyl, isopropyl, butyl, isobutyl, hexyl, cyclohexyl, octyl, 2-ethylhexyl, decyl, stearyl, methoxyethyl, ethoxyethyl, hydroxy, or ethyl, monoesters and diesters of maleic acid, fumaric acid, or itaconic acid, etc. Maleic anhydride is preferred.

A preferred impact modifier is an EPDM polymer or ethylene/propylene copolymer grafted with maleic anhydride. Blends of polyolefins, such as polyethylene, polypropylene, and EPDM polymers with polyolefins that have been grafted with an unsaturated compound containing a carboxyl moiety may be used as impact modifiers.

Other preferred impact modifiers are ionomers, which are carboxyl-group containing polymers that have been partially neutralized with bivalent metal cations such as zinc, manganese, magnesium, or the like. Preferred ionomers are ethylene/acrylic acid and ethylene/methacrylic acid copolymers that have been partially neutralized with zinc. lonomers are commercially available under the Surlyn® trademark from E. I. du Pont de Nemours and Company, Wilmington, Del.

When used, the impact modifier is preferably present in the composition in an amount of from about 3 to about 20 weight percent, or preferably from about 5 to about 15 weight percent, or more preferably from about 8 to about 12 weight percent, based on the total weight of the composition. Even though the weight percent of the impact modifier is relatively low, toughness can be significantly improved in the present invention.

The compositions of the present invention may further comprise other additives such as flame retardants, lubricants, mold-release agents, dyes and pigments, UV light stabilizers, plasticizers, heat stabilizers, anti-oxidants, and inorganic fillers. Other optional additives may be added in any amount consistent with the teachings of the present invention, except that embodiments that would defeat the object of the present invention are hereby excluded.

The compositions of the present invention are melt-mixed blends, wherein all of the polymeric components are well-dispersed within each other and all of the non-polymeric ingredients are dispersed in and bound by the polymer matrix, such that the blend forms a unified whole. Any melt-mixing method may be used to combine the polymeric components and non-polymeric ingredients of the present invention.

For example, the polymeric components and non-polymeric ingredients may be added to a melt mixer, such as, for example, a single or twin-screw extruder; a blender; a kneader; or a Banbury mixer, either all at once through a single step addition, or in a stepwise fashion, and then melt-mixed. When adding the polymeric components and non-polymeric ingredients in a stepwise fashion, part of the polymeric components and/or non-polymeric ingredients are first added and melt-mixed with the remaining polymeric components and non-polymeric ingredients being subsequently added and further melt-mixed until a well-mixed composition is obtained.

The compositions of the present invention may be formed into articles using methods known to those skilled in the art, such as molding, for example, injection molding, blow molding, extrusion, thermoforming, melt casting, vacuum molding, and rotational molding. The composition may be overmolded onto an article made from a different material. The composition may be extruded into films or sheets. The composition may be formed into monofilaments.

The resulting articles may be used in a variety of applications, including housings, automotive parts, electrical goods, electronics components, and construction materials. Preferred articles include gears.

### EXAMPLES

### Preparation of Examples 1-2 and Comparative Examples 1-2

The components shown in Tables 1 were melt-blended in a dual-shaft kneader, extruded, solidified, and cut into pellets. Ingredient quantities are given in weight percent based on the total weight of the composition.

### Preparation of Test Pieces

4.0 mm high×175 mm long×20 mm wide ISO test pieces were formed from the resulting pellets described above using normal molding conditions for non-reinforced nylon resin.

### Measurement of Physical Properties

The test pieces described above were used to measure the physical properties.
Tensile strength, modulus, and elongation at break were measured according to ISO 527-1/-2.
Flexural modulus and flexural strength were measured according to ISO 178.
Notched Charpy impact strength was measured according to ISO 179/1eA.

The following materials were used as the ingredients in the compositions of the examples and comparative examples.
Polyamide A (polyamide 6,6): Zytel® 101, available from DuPont.
Polyamide B (33% Glass Fiber Reinforced polyamide 6,6): Zytel® 70G33HSL, available from DuPont
Polycarbodiimide: Stabaxol P®, an aromatic polycarbodiimide available from Rheinchemie GmbH.
Impact modifier: EPDM rubber grafted with maleic anhydride.
Glass fibers: Chopped strand E-Glass fiber supplied from Owens Corning Co. Ltd
Product Code: CS 03 DE FT2A.

TABLE 1

| | | Comp. | | Comp. | | | Comp. |
|---|---|---|---|---|---|---|---|
| | Ex. 1 | Ex. 1 | Ex. 2 | Ex. 2 | Ex. 3 | Ex. 4 | Ex. 3 |
| Polyamide A | 83 | 85 | 78 | 80 | — | — | — |
| Polyamide B | — | — | — | — | 66.25 | 65.5 | 67 |
| Polycarbodiimide | 2.0 | 0 | 2.0 | 0 | 0.75 | 1.5 | 0 |
| Impact Modifier | 10.0 | 10.0 | 10.0 | 10.0 | 0 | 0 | 0 |
| Glass fiber | 5.0 | 5.0 | 10.0 | 10.0 | 33 | 33 | 33 |
| Tensile strength | 77.1 | 83.7 | 94.7 | 102.7 | 182.0 | 180.0 | 185.0 |
| (MPa) | | | | | | | |
| Elongation at break | 20.4 | 9.1 | 8.6 | 5.5 | 4.2 | 4.8 | 3.0 |
| (%) | | | | | | | |
| Tensile modulus | 2742 | 3235 | 3495 | 4110 | N/E | N/E | N/E |
| (MPa) | | | | | | | |
| Flexural strength | 120.7 | 124.9 | 146.4 | 153.8 | N/E | N/E | N/E |
| (MPa) | | | | | | | |
| Flexural modulus | 2848 | 3078 | 3572 | 3853 | 8800 | 8700 | 9100 |
| (MPa) | | | | | | | |
| Notched Charpy | 21.7 | 12.9 | 20.5 | 14.4 | 15.4 | 15.5 | 12.1 |
| (KJ/m²) | | | | | | | |

Ingredient amounts are given in weight percentages relative to the total weight of the composition.
N/E: Not Evaluated

As is clear from a comparision between Comparative Example 1 and Example 1; and Comparative Example 2 and Examples 2, polyamide compositions containing glass fiber in addition to polycarbodiimide and impact modifier have both significantly improved toughness without significant sacrifice in stiffness and other physical properties. Specifically, notched Charpy and elongation at break meaning toughness significantly improved whilst other physical properties are maintained at the high level.

A comparison of between Examples 3, Example 4, and Comparative Example 3 indicates the significant improvement of toughness by including polycarbodiimide in addition to glass fiber whilst other physical properties are maintained at the high level. The same level of toughness as that of Example 1 and Example 2 can be achieved by a further addition of impact modifier, however, stiffness is reduced drastically in general.

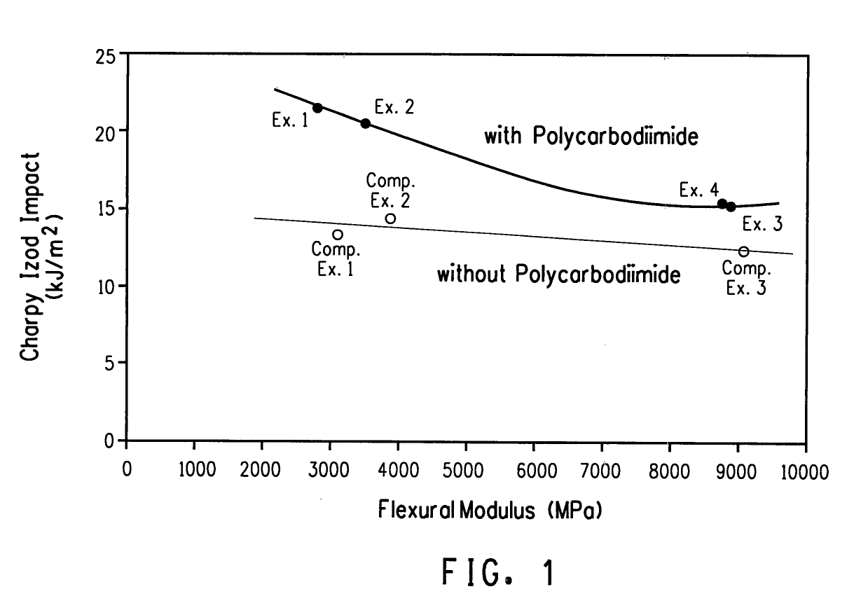

FIG. 1 is a graph illustrating the effect of the present invention. X-axis means Flexural Modulus meaning rigidity or stiffness. Y-axis means Charpy Izod Impact meaning toughness. As clearly shown in FIG. 1, resinous article with high rigidity and toughness can be formed by the addition of carbodiimide.

What is claimed is:

1. A polyamide composition, comprising: (a) at least one polyamide component; (b) glass fibers; and (c) at least one polycarbodiimide component.

2. The composition of claim 1, wherein the composition comprises from about 60 to about 84.7 weight percent of polyamide (a), from about 15 to about 39.7 weight percent of glass fibers (b), and from about 0.3 to about 5 weight percent of polycarbodiimide (c), wherein the weight percentages are based on the total weight of the composition.

3. The composition of claim 1, wherein the at least one polyamide is one or more selected from the group consisting of: polyamide 66/6 copolymer; polyamide 66/68 copolymer; polyamide 66/610 copolymer; polyamide 66/612 copolymer; polyamide 66/10 copolymer; polyamide 66/12 copolymer; polyamide 6/68 copolymer; polyamide 6/610 copolymer; polyamide 6/612 copolymer; polyamide 6/10 copolymer; polyamide 6/12 copolymer; polyamide 6/66/610 terpolymer; polyamide 6/66/69 terpolymer; polyamide 6/66/11 terpolymer; polyamide 6/66/12 terpolymer; polyamide 6/610/11 terpolymer; polyamide 6/610/12 terpolymer; and polyamide 6/66/PACM (bis-p-{aminocyclohexyl}methane)terpolymer.

4. The composition of claim 1, wherein the at least one polyamide is one or more selected from the group consisting of: polyamide 6; polyamide 66; polyamide 46; polyamide 69; polyamide 610; polyamide 612; polyamide 1010; polyamide 11; polyamide 12; semi-aromatic polyamides; a polyamide of hexamethyleneterephthalamide and 2-methylpentamethyleneterephthalamide; a polyamide of hexamethylene isophthalamide and hexamethylene adipamide; a polyamide of hexamethylene terephthalamide, hexamethylene isophthalamide, and hexamethylene adipamide; and copolymers and mixtures thereof.

5. The composition of claim 1, wherein the at least one polyamide is one or more selected from the group consisting of: poly(m-xylylene adipamide); poly(dodecamethylene terephthalamide); poly(decamethylene terephthalamide); poly(nonamethylene terephthalamide); and a polyamide of hexamethylene terephthalamide and hexamethylene adipamide.

6. The composition of claim 4, wherein the polyamide is polyamide 66.

7. The composition of claim 1, further comprising (d) at least one impact modifier.

8. The composition of claim 7, wherein the composition comprises from about 65 to about 84.7 weight percent of polyamide (a), about 3 to about 20 weight percent of glass fibers (b), and about 0.3 to about 5 weight percent of polycarbodiimide (c), and (d) from about 5 to about 15 weight percent of impact modifier, all percentages based on the total weight of the composition.

9. The composition of claim 7, wherein the impact modifier comprises an ethylene-propylene-diene polymer grafted with maleic anhydride or an ethylene-propylene copolymer grafted with maleic anhydride.

10. The composition of claims 7, wherein the impact modifier is an ionomer.

11. The composition of claim 1, wherein the at least one polycarbodiimide is an aliphatic, alicyclic or aromatic polycarbodiimide.

12. An article molded from the composition of claim 1.

13. The article of claim 12 in the form of a gear.
